(19) United States
(12) Patent Application Publication
(10) Pub. No.: US 2024/0409212 A1
(43) Pub. Date: Dec. 12, 2024

(54) PAYLOAD DEPLOYMENT USING A UAV AND RELATED SYSTEMS, DEVICES, AND METHODS

(71) Applicant: Niricson Software Inc., Victoria (CA)

(72) Inventors: Simon V. Borst, Victoria (CA); Joshua G. Columbus, Victoria (CA)

(73) Assignee: Niricson Software Inc., Victoria (CA)

(21) Appl. No.: 18/526,072

(22) Filed: Dec. 1, 2023

Related U.S. Application Data
(63) Continuation of application No. PCT/CA2022/050872, filed on Jun. 1, 2022.
(60) Provisional application No. 63/196,092, filed on Jun. 2, 2021.
(60) Provisional application No. 63/283,291, filed on Nov. 25, 2021.

(51) Int. Cl. B64D 1/02

(52) U.S. Cl. CPC B64D 1/02

(57) ABSTRACT

An embodiment of an unmanned-aerial-vehicle (UAV) system includes a UAV, a payload deployment system, and a payload. The payload deployment system includes a payload attachment system, a payload decoupling system, and, optionally, a payload detachment system. The payload attachment system is configured to attach the payload at a landing site such that the payload is at least partially supported at the landing site. The payload decoupling system is configured to decouple the payload from the UAV such that the UAV can move within a range of motions while the payload remains attached at the landing site. The payload attachment system can be configured to generate a vacuum to cause the payload to attach to the landing site. And the payload decoupling system can include an umbilical that can include a vacuum hose.

### PRIORITY

This application is a continuation of PCT application No. PCT/CA2022/050872 filed 1 Jun. 2022, which claims priority to U.S. Provisional Patent Application 63/196,092, filed 2 Jun. 2021, and to U.S. Provisional Patent Application 63/283,291, filed 25 Nov. 2021, which applications are incorporated by reference herein.

### TECHNICAL FIELD

The present apparatuses, devices, systems, and methods generally relate to Unmanned Aerial Vehicles (UAVs) and UAV operations, and, in particular, relate to positioning a payload at a landing site with a UAV, attaching the payload to the landing site, detaching the payload from the landing site, and carrying the payload away from the landing site with the UAV.

### SUMMARY

A UAV is an aircraft that is configured to fly, and otherwise to operate, without a human pilot on board. A UAV may be a component of an unmanned aircraft system, which may also include a ground-based controller and a system configured facilitate communications between the UAV and the controller. A UAV may operate under remote control by a human operator or by the ground-based controller, or autonomously (or semi-autonomously). Autonomous operation may be controlled by a controller circuit onboard the UAV. Remote control of the UAV may include radio control. A UAV may carry one or more payloads that may include cameras, sensors, and/or supplies, for example.

A UAV may be a rotorcraft with more than two rotors, referred to in the present application as a multirotor. Multirotors can have simpler rotor mechanics for flight control than other rotorcraft, such as a rotorcraft with two or fewer rotors. Owing to their ease of both construction and control, multirotor aircraft can be used in a variety of applications including, but not limited to, reconnaissance, surveillance, law enforcement, inspections, surveying, construction, civil engineering, communication, scientific research, and film-making. In civil-engineering applications, UAVs may advantageously be used for aerial surveys of land, bridges, roads, buildings and the like, asset inventory and assessment, safety inspections, and sensor deployment, for example.

A method of operation of a UAV system, the UAV system comprising a UAV, a payload deployment system, and a payload, the payload deployment system comprising a payload attachment system, a payload decoupling system, and a payload detachment system, may be summarized as comprising attaching, by the payload attachment system, the payload at a landing site, decoupling, by the payload decoupling system, the payload from the UAV, and detaching, by the payload detachment system, the payload from the landing site.

In some embodiments or implementations, the payload attachment system further comprises one or more motors, wherein the attaching, by the payload attachment system, the payload at a landing site includes orienting the payload attachment system relative to the landing site by at least one of the motors. Orienting the payload attachment system relative to the landing site by at least one of the motors may include orienting the payload attachment system by at least one of a yaw motor, a pitch motor, or a roll motor.

In some embodiments or implementations, the payload attachment system further comprises a vacuum system, wherein the attaching, by the payload attachment system, the payload at a landing site includes generating a vacuum by the vacuum system to cause the payload to attach to the landing site.

In some embodiments or implementations, the decoupling, by the payload decoupling system, the payload from the UAV includes decoupling, by the payload decoupling system, the payload from the UAV while the attached payload is at least partially supported at the landing site. The method may further comprise maneuvering the UAV (after the payload is decoupled form the UAV) within a predetermined range of motions.

In some embodiments or implementations, the decoupling, by the payload decoupling system, the payload from the UAV includes decoupling, by the payload decoupling system, the payload from the UAV while the attached payload is fully supported at the landing site.

In some embodiments or implementations, the UAV system further comprises a payload control station comprising a payload controller, the method further comprising actioning, by the payload controller, the payload to perform a task. The payload may comprise one or more sensors, for example, one or more sensors selected from the group including an accelerometer, a microphone, a hydrophone, a contact microphone, a laser vibrometer, an ultrasound sensor, an Eddy current sensor, a surface profiler, and an electromagnetic acoustic transducer, wherein the actioning, by the payload controller, the payload to perform a task includes actioning, by the payload controller, the payload to collect data from at least one of the sensors. The payload may comprise one or more tools, for example, one or more tools selected from the group including a paint sprayer, a marker, a drill, an actuated knife, and a laser, wherein the actioning, by the payload controller, the payload to perform a task includes actioning, by the payload controller, the payload to use at least one of the tools. The payload attachment system may comprise a first Radio Frequency (RF) module, and the payload control station may comprise a second RF module, the second RF module being communicatively coupled to the first RF module, wherein the actioning, by the payload controller, the payload to perform a task may include transmitting commands, by the second RF module to the first RF module. The payload may be mechanically coupled to the UAV via the payload deployment system during a) the attaching, by the payload attachment system, the payload at a landing site, b) the decoupling, by the payload decoupling system, the payload from the UAV, c) the actioning, by the payload controller, the payload to perform a task, and d) the detaching, by the payload detachment system, the payload from the landing site.

In some embodiments or implementations, the detachment system comprises a solenoid, wherein the detaching, by the payload detachment system, the payload from the landing site includes operating the solenoid to push the payload away from the landing site.

An unmanned aerial vehicle (UAV) system may be summarized as comprising a UAV, a payload, a payload deployment system comprising a payload attachment system, a payload decoupling system, and a payload detachment system, and a ground system.

In some embodiments or implementations, the payload attachment system is configured to attach the payload at a landing site, the payload decoupling system is configured to decouple the payload from the UAV, the decoupled payload being at least partially supported at the landing site, and the decoupled UAV being free to move within a predetermined range of motions, and the payload detachment system is configured to cause the payload to detach from the landing site. The payload attachment system may comprise one or more motors configured to orient the payload attachment system relative to the landing site, one or more sensors, an RF module communicatively coupled to the ground system, and a controller configured to receive data from the sensors and issue commands to the one or more motors, and the RF module. The one or more motors may include at least one of a yaw motor, a pitch motor, and a roll motor. The payload attachment system may further comprise a vacuum system comprising a vacuum motor and a vacuum cup pneumatically coupled to the vacuum motor, a pressure sensor configured to determine an air pressure in the vacuum cup, and one or more ultrasonic sensors. The detachment system may comprise a vacuum-release mechanism configured to adjust an attachment force to allow detachment.

In some embodiments or implementations, the detachment system comprises a solenoid configured to push the payload away from the landing site.

In some embodiments or implementations, the decoupling system comprises an umbilical mechanically coupled at one end to an upper portion of the payload attachment system, the umbilical mechanically coupled at the other end to a lower portion of the payload, and the umbilical configured to allow the UAV to move within a predetermined range of motions when the payload is attached to the landing site.

In some embodiments or implementations, the decoupling system comprises one or more flexible, semi-rigid, or rigid arms, one or more rotators, a telescope system, and a counterweight.

In some embodiments or implementations, the payload comprises one or more sensors, for example, one or more sensors selected from the group including an accelerometer, a microphone, a hydrophone, a contact microphone, a laser vibrometer, an ultrasound sensor, an Eddy current sensor, a surface profiler, and an electromagnetic acoustic transducer.

In some embodiments or implementations, the payload comprises one or more tools, for example, one or more tools selected from the group including a paint sprayer, a marker, a drill, an actuated knife, and a laser.

In some embodiments or implementations, the ground system comprises a UAV control station and a payload control station. The payload attachment system may comprise a first RF module, and the payload control station may comprise a second RF module, wherein the second RF module is communicatively coupled to the first RF module to transmit commands and to receive data.

An unmanned aerial vehicle (UAV) system may be summarized as comprising a UAV, and a payload deployment system comprising a payload attachment system, a payload decoupling system, and a payload detachment system. In some embodiments or implementations, the payload attachment system is configured to attach at least a portion of the payload attachment system at a landing site, the payload decoupling system is configured to decouple at least a portion of the payload attachment system from the UAV, the decoupled at least a portion of the payload attachment system being at least partially supported at the landing site, and the decoupled UAV being free to move within a predetermined range of motions, and the payload detachment system is configured to detach the at least a portion of the payload attachment system from the landing site. The at least a portion of the payload attachment system may include an integrated payload.

In some embodiments or implementations, the payload attachment system is configured to attach a payload at a landing site, the payload decoupling system is configured to decouple the payload from the UAV, the decoupled payload being at least partially supported at the landing site, and the decoupled UAV being free to move within a predetermined range of motions, and the payload detachment system is configured to cause the payload to detach from the landing site.

An embodiment of a payload deployment system for deploying a payload from a UAV may be summarized as comprising at least one of:
a payload attachment system;
a payload decoupling system; and
a payload detachment system.

An embodiment of a method of operation of a UAV system, the UAV system comprising a UAV and a payload attachment system, may be summarized as comprising attaching, by the payload attachment system, the payload at a landing site.

An embodiment of a UAV such as described above can be configured to place a payload at a location not easily accessible by ladder, lift, or other means, to leave the payload to perform one or more functions, and then to retrieve the payload from the location.

An embodiment of a UAV such as described above can be configured to place a payload at a location not easily accessible by ladder, lift, or other means, to remain attached to the payload while the payload performs one or more functions, and then to remove the payload from the location. In such an embodiment, the UAV can provide power, communications capabilities, and other functionality and operability to the payload.

### BRIEF DESCRIPTION OF THE DRAWINGS

The various elements and acts depicted in the drawings are provided for illustrative purposes to support the detailed description but are not intended to be limiting. Unless the specific context requires otherwise, the sizes, shapes, and relative positions of the illustrated elements and acts are not necessarily shown to scale and are not necessarily intended to convey any information or limitation. In general, identical reference numbers are used to identify similar elements or acts.

FIG. 1 is a block diagram of an example implementation of a UAV system, in accordance with an embodiment.

FIG. 2 is a block diagram of example implementations of the UAV and UAV control station shown in FIG. 1, in accordance with an embodiment.

FIG. 3 is a block diagram of example implementations of the upper and lower portions of the payload-deployment system shown in FIG. 1, in accordance with an embodiment.

FIG. 4 is a flow diagram showing an exemplary method of operation of a UAV (for example, the UAV shown FIG. 1), in accordance with an embodiment.

FIGS. 5A, 5B, 5C are schematic drawings illustrating an example operational sequence of a loaded UAV (for example, the UAV, payload deployment system, and payload shown in FIG. 1), in accordance with an embodiment.

FIGS. 6A, 6B, 6C are schematic drawings of views of an example loaded UAV (for example, the UAV, payload deployment system, and payload shown in FIG. 1), in accordance with an embodiment.

FIG. 7A is a bottom view of a loaded UAV 700 (for example, the UAV, payload deployment system, and payload of FIG. 1), in accordance an embodiment.

FIG. 7B is a close-up of the bottom view of FIG. 7A in accordance with an embodiment.

FIGS. 8A, 8B, and 8C are schematic diagrams illustrating an example sequence as a loaded UAV (for example, the UAV, payload deployment system, and payload of FIG. 1) approaches, and attaches to, a landing site on a structure, in accordance with an embodiment.

FIGS. 9A, 9B, and 9C are schematic diagrams illustrating an example undocking sequence during which a payload is deployed, in accordance with an embodiment.

FIGS. 10A, 10B, 10C, 10D and 10E are schematic diagrams illustrating the structures and functionality of various example implementations of a decoupling system, in accordance with an embodiment.

FIG. 11A is a schematic diagram of an example detachment system, in accordance with an embodiment.

FIGS. 11B, 11C, and 11D are close-ups of the detachment system of FIG. 11A and illustrate a detachment sequence of the detachment system, in accordance with an embodiment.

### DETAILED DESCRIPTION

The following description sets forth specific details in order to illustrate and provide an understanding of the various implementations and embodiments of the present systems, devices, and methods. A person of skill in the art will appreciate that some of the specific details described herein may be omitted or modified in alternative implementations and embodiments, and that the various implementations and embodiments described herein may be combined with each other and/or with other methods, components, materials, etc. in order to produce further implementations and embodiments.

In some instances, well-known structures and/or processes associated with computer systems and data processing have not been shown or provided in detail in order to avoid unnecessarily complicating or obscuring the descriptions of the implementations and embodiments.

Unless the specific context requires otherwise, throughout this specification and the appended claims the term “comprise” and variations thereof, such as “comprises” and “comprising,” are used in an open, inclusive sense to mean “including, but not limited to.”

Unless the specific context requires otherwise, throughout this specification and the appended claims the singular forms “a,” “an,” and “the” include plural referents. For example, reference to “an embodiment” and “the embodiment” include “embodiments” and “the embodiments,” respectively, and reference to “an implementation” and “the implementation” include “implementations” and “the implementations,” respectively. Similarly, the term “or” is generally employed in its broadest sense to mean “and/or” unless the specific context clearly dictates otherwise.

The headings and Abstract of the Disclosure are provided for convenience only and are not intended, and should not be construed, to interpret the scope or meaning of embodiments of the present systems, devices, and methods.

### Overview

It can be beneficial for a UAV payload to be able to attach to a landing site. A landing site may be surface, a cable, a rope, or a tree branch, for example. A landing surface may be a hard surface (e.g., concrete, asphalt, rock, ice), a soft surface (e.g., sand or organic material), or a liquid surface (e.g., a water surface). In some situations, it can be desirable for the UAV payload to be able to attach to a landing site and be at least partially supported at the landing site by the UAV or by the landing site.

Landing sites may be difficult or dangerous to access by other means (e.g., by a human operator). UAV access to a landing site can be desirable for reasons that include, but are not limited to, taking sensor readings, performing rework at the landing site, marking of the landing site, inspecting the landing site and its immediate environment, and depositing, and/or removing, an object from the landing site.

Landing sites in general, and surfaces in particular, may vary in their material properties. For example, surfaces may vary in their degrees of hardness and roughness, and may vary in their magnetic properties. Surfaces may vary in the angles they subtend with respect to a horizontal plane. For example, surfaces may be horizontal, vertical, or inclined. Surfaces may be upward-facing or overhanging.

Existing devices for attaching a UAV payload to a surface may rely on magnetic properties of the surface, which can limit the types of surfaces to which a UAV payload can be attached. Existing devices for attaching a UAV payload to a surface are generally unable to attach a UAV payload to surfaces at a wide range of angles (including, e.g., ceilings) unless the surfaces are magnetic or the UAV has been custom-built for the application.

Existing devices for attaching a UAV payload to a surface may require the UAV to supply a force normal to the surface to attach the payload to the surface. A shortcoming of devices that require the UAV supply a normal force to attach the payload is that the UAV may not be able to fully support the payload unless the UAV can maintain a position with sufficient precision to prevent the payload from unintentionally detaching from the surface. Environmental conditions (e.g., high wind) can add further risk to the payload and the UAV. Furthermore, the approach can require a UAV control system that is able to handle a variety of payload properties (e.g., payload weight and position). The UAV control system may need to be so complex that it is beyond the capability of typical commercial off-the-shelf UAVs.

The various embodiments described herein are systems, devices, and methods configured to attach, and for attaching, a UAV payload to a landing site (including the various types of landing sites described above and below), and for temporarily decoupling the payload from the UAV. The technology embodiments described below include a payload deployment system that includes at least one of a payload attachment system, a decoupling system, and a detachment system. The technology can be used to attach a payload at a wide variety of different landing sites (including surfaces at various angles, cables, and the like). The technology can be integrated with a commercial off-the-shelf (COTS) UAV and/or a custom UAV. Being able to use a COTS UAV can save significant cost and complexity as compared to a custom UAV, although a custom UAV may be more suitable than a COTS UAV in some applications.

Attachment of the payload at the landing site refers to an attaching of the payload such that the payload is at least partially supported at the landing site. Decoupling of the payload refers to a decoupling of the payload from the UAV such that the UAV is able to move within a range of motions while the payload remains attached at the landing site. In some embodiments or implementations, the decoupled payload remains mechanically coupled to the UAV by an umbilical. In other embodiments or implementations, the decoupled payload is mechanically decoupled from the UAV, for example, by use of a docking/undocking system. Detachment refers to an action of the payload attachment system that causes the payload to release, or move away from, the landing site.

### UAV System

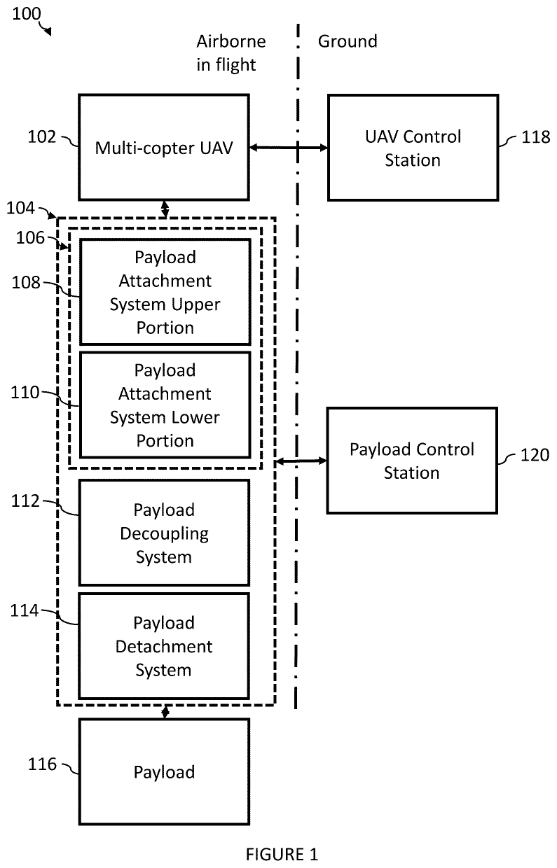

FIG. 1 is a block diagram of an example of a UAV system 100, in accordance with an embodiment. UAV system 100 includes a UAV 102. UAV 102 may be a multi-copter UAV, for example. UAV system 100 further includes a payload deployment system 104. Payload deployment system 104 includes a) a payload attachment system 106 comprising an upper portion 108 and a lower portion 110, b) a payload decoupling system 112, and c) a payload detachment system 114.

UAV system 100 also can include a payload 116. Payload 116 is mechanically coupled to payload attachment system 106. UAV 102, payload deployment system 104, and payload 116 may be airborne at various times during operation of UAV 102. As described below, UAV 102 may be airborne while payload 116 and at least some elements of payload deployment system 104 are attached at a landing site and not airborne.

In operation according to an embodiment, payload attachment system 106 may be used to attach a payload to a landing site, as described in more detail below. A landing site may be a surface. Payload attachment system 106 includes an upper portion 108 and a lower portion 110. Upper portion 108 is mechanically coupled to UAV 102.

UAV system 100 also includes a UAV control station 118, and a payload control station 120. UAV control station 118 and payload control station 120 are typically located on the ground (or otherwise remote from UAV 102, payload deployment system 104, and payload 116). UAV control station 118 is communicatively coupled to UAV 102 and is configured to control and operate UAV 102, at least to facilitate such control and operation by a human operator. Payload control station 120 is communicatively coupled to payload deployment system 104, and is configured to control and to operate payload deployment system 104 and/or payload 116. UAV control station 118 may be communicatively coupled to payload deployment system 104 and/or payload 116, either directly or via UAV 102 (or both) and may be configured to control and to operate payload deployment system 104 and/or payload 116. Furthermore, UAV control station 118 and payload control station 120 may be part of a same ground unit or may be physically separate from one another.

UAV 102, payload deployment system 104, and payload 116 are collectively referred to in the present application as a UV system, a loaded UAV system, or a loaded UAV.

Payload 116 may, for example, be a collection of sensors attached to UAV 102 prior to a mission. The mission may include one or more tasks. The sensors may be selected according to the mission to be performed. The sensors may be used to perform an inspection of one or more objects or spaces. The sensors may include an accelerometer, a microphone, a hydrophone, a contact microphone, a laser vibrometer, an ultrasound sensor, an Eddy current sensor, a surface profiler, and/or an electromagnetic acoustic transducer (EMAT), for example. The sensors also may include a high-definition visual camera, one or more actuators (e.g., solenoids), a spectral sensor, a gas sensor, and/or a navigation sensor.

Payload 116 may, for example, include one or more tools, e.g., a paint sprayer, a marker, a drill, an actuated knife, or a laser.

Payload deployment system 104 may include one or more motors. Payload deployment system 104 may include a motorized gimbal.

UAV 102 may include a UAV landing structure. The UAV landing structure may be able to be oriented (e.g., upwards, downwards, lateral, and/or any angle in between) so that UAV 102 can land on surfaces with various orientations. UAV 102 may include an attachment system (separate from payload deployment system 106) for attaching UAV 102 to a surface.

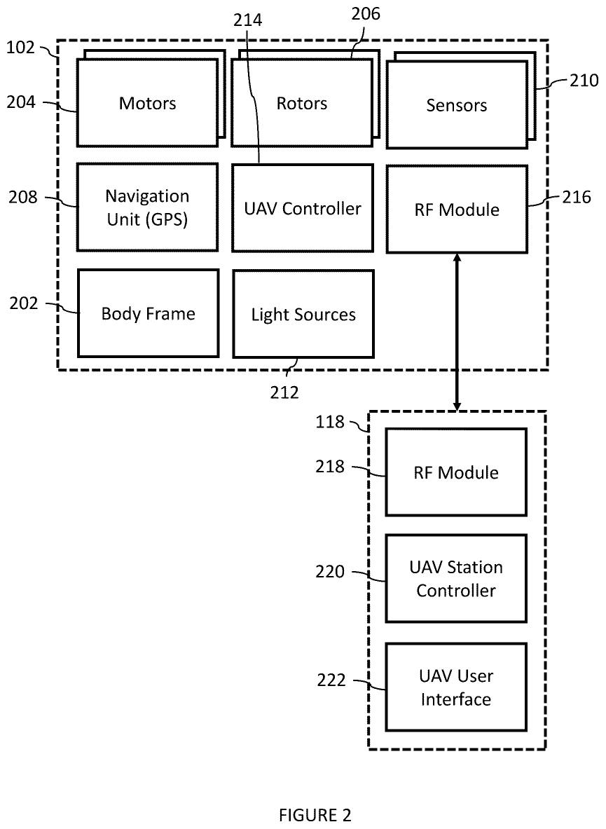

Alternate embodiments of the UAV system 100 of FIG. 1 are contemplated. For example, one or more embodiments described in conjunction with FIGS. 2-11D may be applicable to the UAV system 100 of FIG. 1.

FIG. 2 is a block diagram of example implementations of UAV 102 and UAV control station 118 of FIG. 1, in accordance with an embodiment. UAV 102 includes body frame 202, motors 204, and rotors 206. UAV 102 also includes a navigation unit 208, sensors 210, and, in some embodiments or implementations, light sources 212. Navigation unit 208 may include a GPS receiver. Sensors 210 may include a visual sensor and/or a proximity sensor, for example. Light sources 212 may be used for night operations or inspection of dark spaces, for example. UAV 102 also includes a UAV controller 214. UAV controller 214 may include one or more processor circuits such as microprocessors, microcontrollers, field-programmable gate arrays (FPGAs), or other logic circuitry configurable with software, firmware, a configuration data, or a combination or sub-combination of software, firmware, or configuration data.

UAV 102 also includes an RF module 216 for RF communication to other components of UAV system 100, for example to an RF module 218 of UAV control station 118 (FIG. 1). Each of RF modules 216 and 218 may include a respective RF transceiver. UAV control station 118 also includes a UAV station controller 220 and a UAV user interface 222. UAV user interface 222 may include a display and/or a joystick, for example. UAV station controller 220 may include one or more processor circuits such as a microprocessor, microcontroller, FPGA, or other logic circuitry configurable with software, firmware, configuration date, or a combination or sub-combination of software, firmware, or configuration data.

Alternate embodiments of the UAV 102 of FIG. 2 are contemplated. For example, the UAV 102 may include additional electronic and mechanical parts not shown in FIG. 2. Furthermore, one or more embodiments described in conjunction with FIGS. 1 and 3-11D may be applicable to the UAV 102 of FIG. 2.

### Payload Attachment System

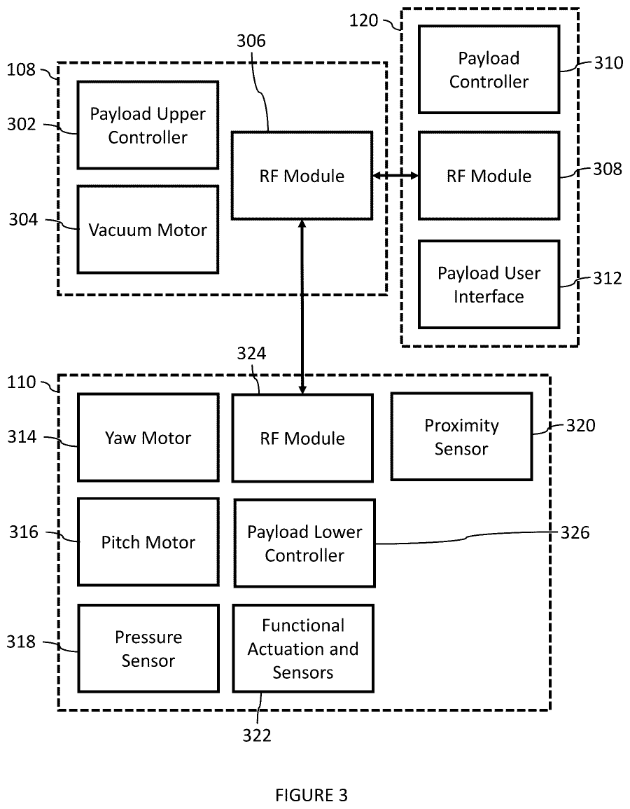

FIG. 3 is a block diagram of example implementations of upper portion 108 and lower portion 110 of payload attachment system 106 of FIG. 1, in accordance with an embodiment.

In some embodiments or implementations, the payload attachment system 106 (FIG. 1) uses suction, adhesion, and/or Van der Waals forces, alone or in combination, to attach a payload to a surface. In some implementations, friction can be used to attach to a landing site. In some implementations, thrust can be used to hold a payload at the landing site. Thrust can be provided, for example, by a propeller, jet engine, rocket, and/or a downdraft of the UAV.

In some embodiments or implementations, the payload is at least partially supported by the payload attachment system 106 (FIG. 1) at the landing site. In some embodiments or implementations, both the payload 116 (FIG. 1) and the UAV 102 (FIG. 1) are at least partially supported by the payload attachment system 106 at the landing site, e.g., via a rigid umbilical or with the UAV suspended from the attachment at the landing site.

The following description of an embodiment is for a payload attachment system 106 (FIG. 1) that uses suction, alone or in combination with other methods, to attach the payload 116 (FIG. 1) at the landing site. Implementations using adhesive or Van der Waals (electrostatic) forces may include an actuator not shown in FIG. 3.

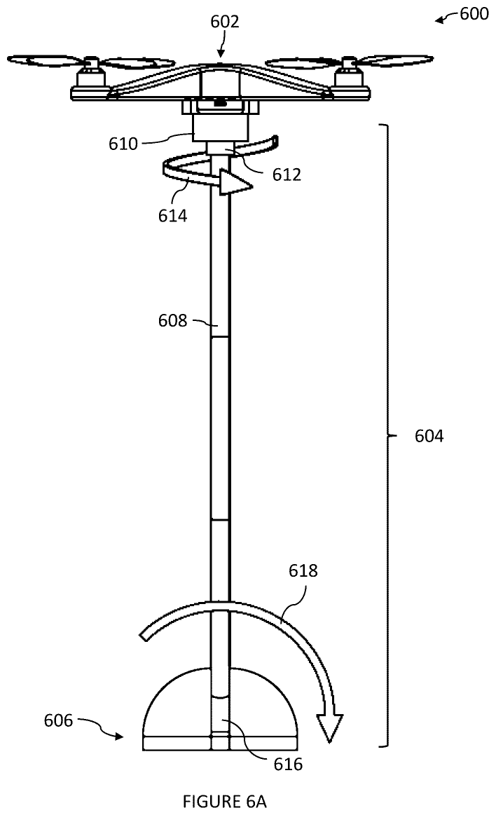

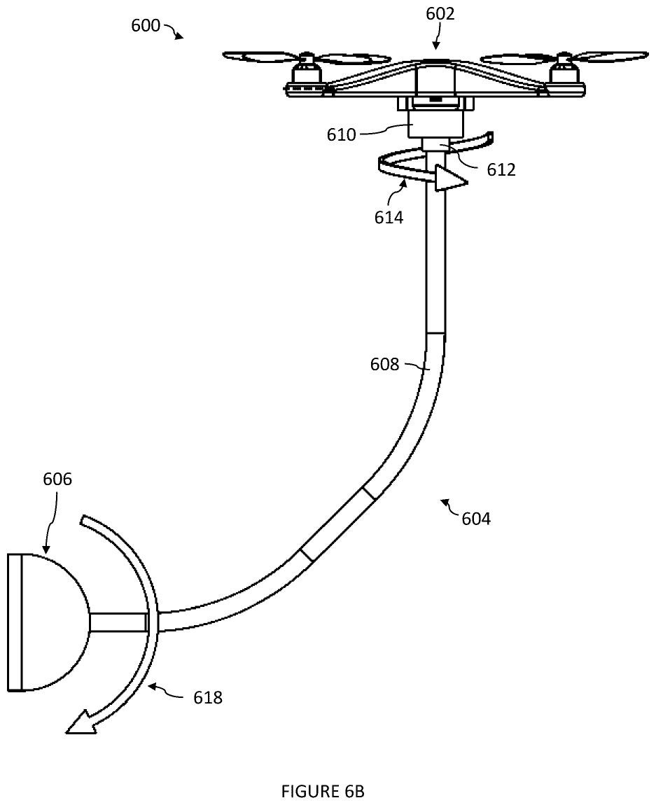

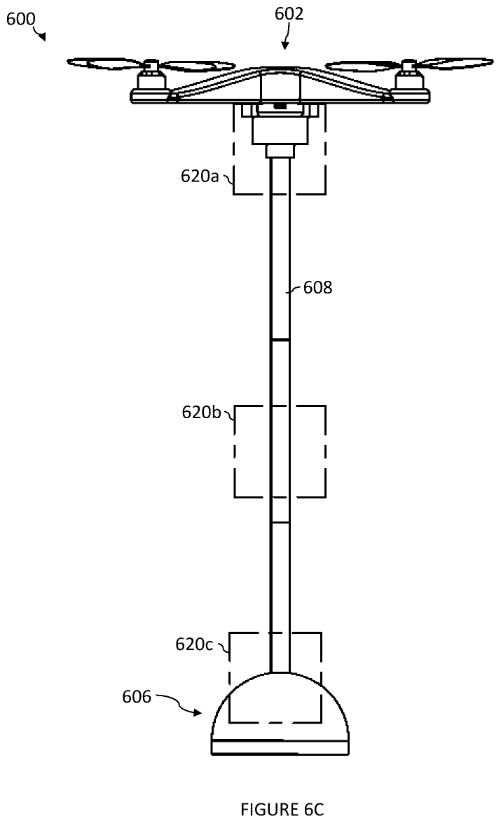

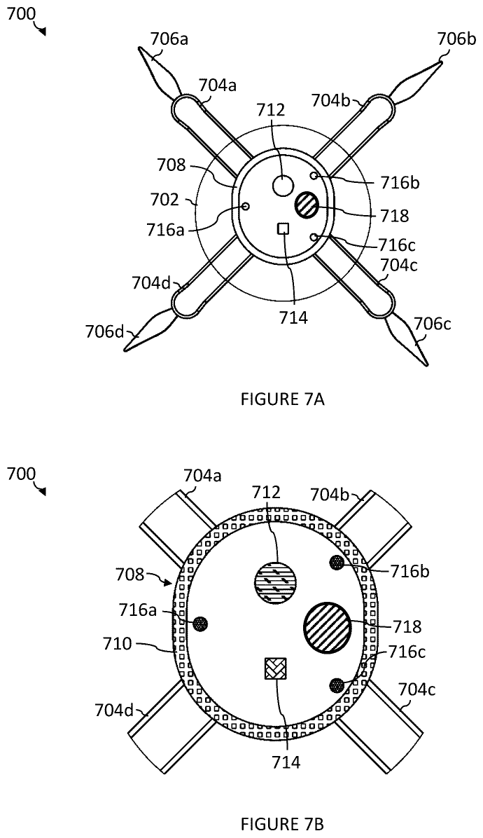

Still referring to FIG. 3, upper portion 108 of payload attachment system 106 (FIG. 1) includes a payload upper controller 302, a vacuum motor 304, and an RF module 306. RF module 306 can be communicatively coupled to an RF module 308 of payload control station 120. Payload control station 120 also includes a payload controller 310 and a payload user interface 312. Vacuum motor 304 may be part of a vacuum system. Other components of the vacuum system can include a vacuum cup (see, e.g., vacuum cup 708 of FIG. 7) and a vacuum hose (see, e.g., the vacuum hose of umbilical 608 of FIG. 6). The vacuum system may include a vacuum seal. The vacuum seal may include a natural foam rubber material, for example.

Payload attachment system 106 may have multiple degrees of freedom. Lower portion 110 may include one or more motors. In some embodiments or implementations, one or more of the motors is a gimbal motor. In some embodiments or implementations, the one or more motors include one or more of a yaw motor, a pitch motor, and a roll motor. In the illustrated example of FIG. 3, lower portion 110 includes a yaw motor 314 and a pitch motor 316.

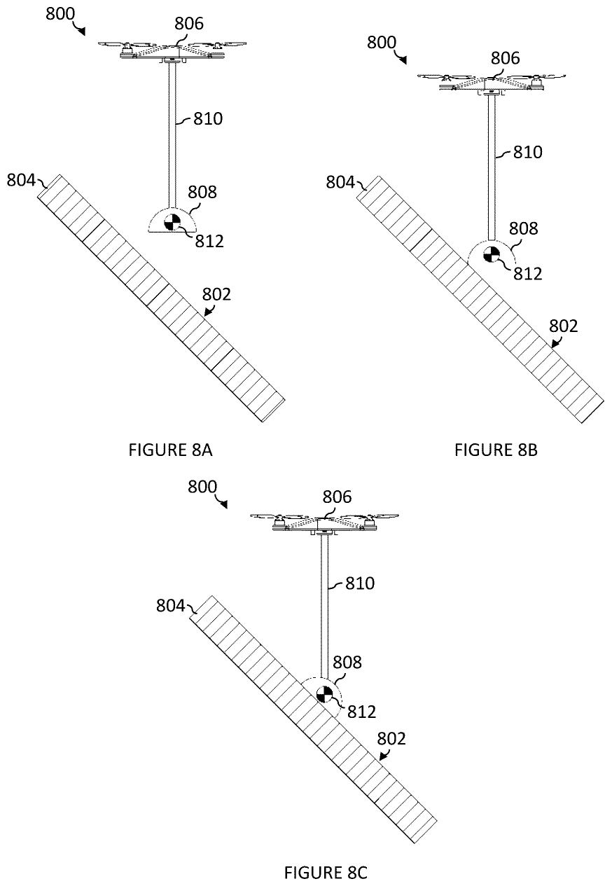

More generally, lower portion 110 of payload attachment system 106 may include a variety of motors. One or more of the motors may spin freely by powering down, by use of a clutch, or by use of another suitable mechanism. In some embodiments or implementations, the motors can act as a hinge when powered down, in which case (as illustrated in FIGS. 8A, 8B, and 8C, for example) lower portion 110 can approach a landing site, and one or more of the motors are configured to orient lower portion 110 relative to the landing site, using gravity to cause lower portion 110 to hinge, for example. In other embodiments or implementations, one or more of the motors can cause the payload attachment system 106 (FIG. 1) to orient lower portion 110 relative to the landing site. Lower portion 110 also includes the following sensors: a) a pressure sensor 318, b) a proximity sensor 320, and c) functional and actuation sensors 322.

Lower portion 110 also includes an RF module 324, which can be communicatively coupled to RF module 306 of upper portion 108. Each of RF modules 306 and 324 may include a respective RF transceiver.

Lower portion 110 also includes a payload lower controller 326.

Referring to FIGS. 2-3, the processor circuits of UAV controller 214, UAV station controller 220, payload controller 310, payload upper controller 302, and payload lower controller 326 may include, for example, one or more microprocessors, microcontrollers, central processor units (CPUs), graphics processor units (GPUs), application specific integrated circuits (ASICs), field programmable gate arrays (FPGAs), or programmable logic controllers (PLCs), which execute commands, for instance in the form of instructions stored as software or firmware instructions in one or more non-transitory computer- or processor-readable media such as memory (e.g., erasable or non-erasable nonvolatile memory, volatile memory, read only memory, random access memory, flash memory, spinning magnetic or optical media), or which are topologically configured in response to firmware or configuration data.

Referring to FIGS. 1 and 3, payload attachment system 106 may transmit data to, and may receive data from, payload control station 120 and/or UAV control station 118. Transmitted data may include status updates and error codes, for example. Transmitted data may also include data from the payload 116. Payload data may be stored at the payload 116 and transmitted at a later time (e.g., after the data is stored), or may be transmitted in real-time or near real-time. Payload data may include, for example, audio files, pressure readings, and/or images. Payload data may be stored on a removable medium, for example a Universal-Serial-Bus (USB) drive (not shown in FIGS. 1 and 3). Received data may include a manual override, for example.

Alternate embodiments of the upper portion 108 and the lower portion 110 of the payload attachment system 116 (FIG. 1) are contemplated. For example, one or more embodiments described in conjunction with FIGS. 1-2 and 4-11D may be applicable to the upper and lower payload-attachment-system portions 108 and 110 of FIG. 3.

Operation of UAV with Payload Attachment System

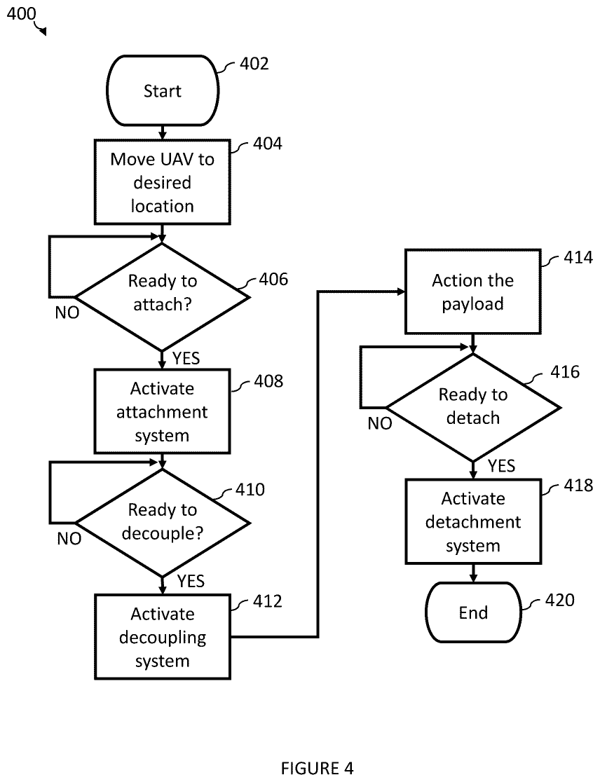

FIG. 4 is a flow diagram showing an exemplary method 400 of operation of a UAV (for example, UAV 102 of FIG. 1), in accordance with an embodiment. Method 400 includes ten steps 402, 404, 406, 408, 410, 412, 414, 416, 418, and 420, though it will be appreciated that in alternative embodiments or implementations certain steps may be omitted and/or additional steps may be added. It also will be appreciated that the illustrated order of the steps is shown for exemplary purposes only and may change in alternative implementations.

A payload can be integrated with a payload deployment system. Attaching the payload to a surface, and detaching the payload from the surface, can include attaching and detaching, respectively, a portion of the payload deployment system.

Referring to FIGS. 1-4, at step 402, method 400 starts, for example in response to a command to initiate a UAV mission.

At a step 404, the UAV 102 moves to a location. The location may be a predetermined location. The location may be specified by a human operator or an external system. The UAV may be returning to a previous location. The location may be the location of a landing site for a UAV payload. The landing site may be a position or region of a surface.

In response to the UAV 102 determining, at step 406, that the UAV is ready to attach to the landing site, method 400 proceeds to step 408, during which the UAV activates the payload attachment system 106 to cause the UAV payload 116 to attach at the landing site.

In response to the UAV 102 determining, at step 410, that the UAV is ready to decouple the payload 116 from the UAV, method 400 proceeds to step 412, during which the UAV activates a decoupling system 112 to cause the UAV payload to decouple from the UAV. The UAV 102 may determine that it is ready to decouple the payload 116 when the payload is attached and fully supported at the landing site, for example.

At step 414, once the payload 116 is attached at the landing site, and decoupled from the UAV 102, the payload can be actioned, for example, by the payload control station 120.

When the UAV 102 determines, at step 416, that the payload 116 is ready to be detached from the landing site, method 400 proceeds to step 418, at which the UAV activates the payload detachment system 114 to cause the payload to be removed from the landing site.

At step 420, method 400 ends.

Alternate embodiments of the method 400 of FIG. 4 are contemplated. For example, one or more embodiments described in conjunction with FIGS. 1-3 and 5-11D may be applicable to the method 400 of FIG. 4.

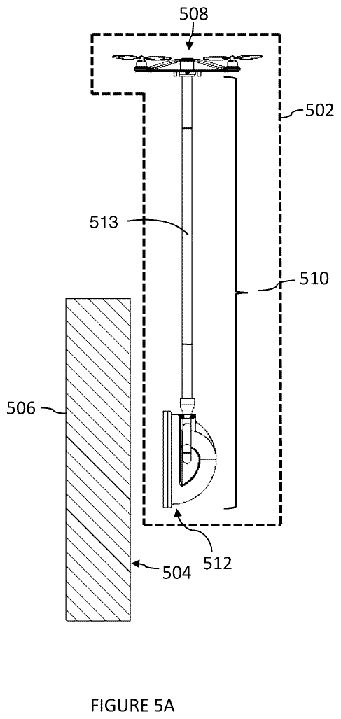

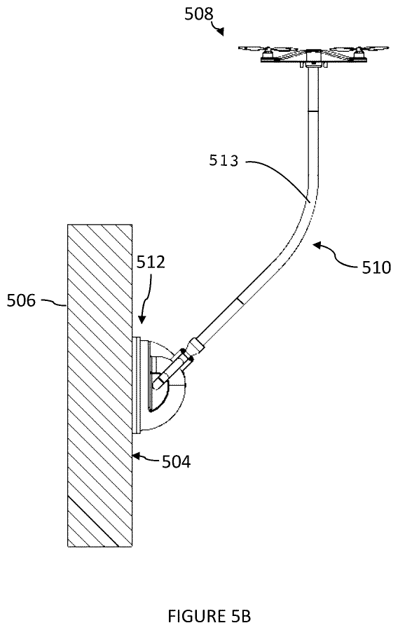

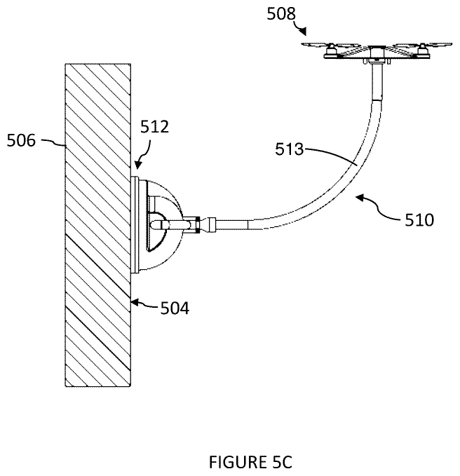

FIGS. 5A, 5B, 5C are schematic drawings illustrating an example operational sequence of a loaded UAV 502 (for example, UAV 102, payload deployment system 104, and payload 116 of FIG. 1), in accordance with an embodiment.

FIG. 5A shows loaded UAV 502 approaching a landing site 504 on a structure 506. Loaded UAV 502 includes a UAV 508, a payload deployment system 510, and a payload (not visible in FIGS. 5A through 5C). The payload can be integrated with a lower portion 512 of payload deployment system 510. Integration of the payload with the payload deployment system 512 (or with the payload attachment system 116 (FIG. 1) of a payload deployment system 510) is described with reference to FIGS. 7A and 7B. Payload 512 is supported by UAV 508 via payload deployment system 510. Payload is oriented for landing on the landing site 504, for example, by yaw and pitch motors (not visible in FIG. 5A) on payload deployment system 510.

FIG. 5B shows loaded UAV 502 with lower portion 512 of payload deployment system 510 attached at landing site 504, and in the process of decoupling from UAV 508. Payload deployment system 510 includes a payload decoupling system, which includes an umbilical 513 that may be flexible, semi-rigid, or rigid. Umbilical 513 may include or consist of a vacuum hose (not shown in FIG. 5B), for example. As described with reference to FIG. 3, lower portion 512 may use suction, adhesion, and/or Van der Waals forces, alone or in combination, to attach to a surface of the landing site 504.

FIG. 5C shows loaded UAV 502 with lower portion 512 of payload deployment system is fully supported by the attachment system at landing site 504, while UAV 508 is allowed to have a range of motion by the payload decoupling system.

Alternate embodiments of the loaded UAV 502 of FIGS. 5A-5C are contemplated. For example, one or more embodiments described in conjunction with FIGS. 1-4 and 6A-11D may be applicable to the loaded UAV 502 of FIGS. 5A-5C.

FIGS. 6A, 6B, 6C are schematic drawings of views of an example loaded UAV 600 (for example, the UAV 102, payload deployment system 104, and payload 116 shown in FIG. 1), in accordance with an embodiment.

FIG. 6A is a side view of loaded UAV 600 prior to deployment of the payload. Loaded UAV 600 includes UAV 602, payload deployment system 604, and a lower portion 606 of payload deployment system 604. The payload can be integrated with lower portion 606 and is not visible in FIG. 6A. An integrated payload is described with reference to FIGS. 7A and 7B. Payload deployment system 604 includes a payload attachment system (not distinguished in FIG. 6A), a payload decoupling system, and (optionally) a payload detachment system (not distinguished in FIG. 6A). Payload decoupling system (described in more detail below) includes an umbilical 608 which may be flexible, semi-rigid, or rigid. Umbilical 608 may include or consist of a vacuum hose (not shown in FIG. 6A), for example. Payload deployment system 604 may include a mounting for umbilical 608.

The payload attachment system of payload deployment system 604 includes a vacuum motor 610, which can provide a vacuum via the vacuum hose of umbilical 608 to secure lower portion 606 at a landing site. In some implementations, the vacuum provided by vacuum motor 610 via the vacuum hose of umbilical 608 can fully support lower portion 606. Vacuum motor 610 can be controlled to adjust a strength of vacuum securing lower portion 606 at a landing site. Vacuum motor 610 can be throttled to reduce an attachment force, thereby allowing UAV 602 to remove lower portion 606 from the landing site. The payload attachment system may include a vacuum release mechanism configured to adjust the attachment force to allow detachment while preventing lower portion 606 from falling under gravity, e.g. by throttling vacuum motor 610. For example, the vacuum may be reduced to a vacuum sufficiently strong to prevent lower portion 606 from falling off the surface yet sufficiently weak to allow UAV 602 to remove lower portion 606 from the surface. Vacuum motor 610 may be one of various vacuum pump and/or blower fans, and/or a combination of them.

The payload attachment system of payload deployment system 604 includes a yaw motor 612 mechanically coupled to UAV 602. Yaw motor 612 may be a gimbal yaw motor. Yaw motor 612 can provide orientation of lower portion 606 in a direction of arrow 614 (or in an opposite direction). The payload attachment system of payload deployment system 604 also includes a pitch motor 616, which can provide orientation of lower portion 606 in a direction of arrow 618 (or in an opposite direction). Pitch motor 616 may be a gimbal pitch motor.

In some implementations, umbilical 608 is torsionally rigid so that UAV 602 can control rotational motion about a longitudinal axis of umbilical 608. Umbilical 608 can allow UAV 602 to have a range of motion while lower portion 606 is attached at a landing site and decoupled from UAV 602.

FIG. 6B is a side view of loaded UAV 600 of FIG. 6A during deployment of lower portion 606 of payload deployment system 604.

FIG. 6C is a side view of loaded UAV 600 of FIG. 6A showing examples of possible locations 620 for vacuum motor 610 on the payload attachment system of payload deployment system 604. Vacuum motor 610 may be located at location 620a in an upper portion of the payload attachment system, at one end of the vacuum hose of umbilical 608. Vacuum motor 610 may be mounted on UAV 602. Vacuum motor 610 may be mounted at location 620a to reduce noise at the payload. Vacuum motor 610 may be located at location 620b along the vacuum hose of umbilical 608, and approximately mid-way between UAV 602 and payload 606. Alternatively, vacuum motor 610 may be located at location 620c in a lower portion of the payload attachment system, at the payload end of the vacuum hose of umbilical 608.

Alternate embodiments of the loaded UAV 600 of FIGS. 6A-6C are contemplated. For example, one or more embodiments described in conjunction with FIGS. 1-5C and 7A-11D may be applicable to the loaded UAV 600 of FIGS. 6A-6C.

FIG. 7A is a bottom view of a loaded UAV 700 (for example, UAV 102, payload deployment system 104, and payload 116 of FIG. 1), in accordance with an embodiment. Loaded UAV 700 includes a body frame 702, rotor assemblies 704a, 704b, 704c, and 704d, and propellors 706a, 706b, 706c, and 706d.

Lower portion 708 of the payload attachment system includes a vacuum cup 708, a vacuum inlet 712, a pressure sensor 714, and ultrasonic sensors 716a, 716b, and 716c (collectively referred to as ultrasonic sensors 716). Lower portion 708 further includes a payload 718.

Vacuum cup 708 can attach to a surface of a landing site. Pressure sensor 714 measures an air pressure in the vacuum cup and can be read by a processor circuit such as a microcontroller and can be used to control a throttle of the vacuum motor to maintain a desired suction force. Vacuum cup 708 may be pneumatically coupled to a vacuum motor (e.g., vacuum motor 304 of FIG. 3).

Ultrasonic sensors 716 can operate in conjunction with a processor circuit such as a microcontroller of the payload attachment system (e.g., payload lower controller 326 of FIG. 3) to control a yaw motor and a pitch motor to position vacuum cup 708 parallel to a surface of a landing site for attachment.

FIG. 7B is a close-up of the bottom view of loaded UAV 700 of FIG. 7A, in accordance with an embodiment. Vacuum cup 708 includes a vacuum seal 710. Vacuum seal 710 may include a compressible rubber foam that can spring back elastically after compression.

Alternate embodiments of the loaded UAV 700 of FIGS. 7A-7B are contemplated. For example, one or more embodiments described in conjunction with FIGS. 1-6C and 8A-11D may be applicable to the loaded UAV 700 of FIGS. 7A-7B.

FIGS. 8A, 8B, and 8C are schematic diagrams illustrating an example sequence as a loaded UAV 800 ((for example, UAV 102, payload deployment system 104, and payload 116 of FIG. 1) approaches and attaches, by the payload deployment system, at a landing site 802 on a structure 804, in accordance with an embodiment. UAV 800 includes a lower portion 808 of a payload attachment system, and an umbilical 810. A payload can be integrated with lower portion 808. In some embodiments or implementations, as described previously, umbilical 810 includes a vacuum hose. An attachment point of the payload to umbilical 810 can be selected to be proximate to a center of mass 812 of lower portion 808 so that, when contacting a surface of the landing site 802, lower portion 808 is caused to rotate, by a moment of a force normal to the surface of the landing site, to bring a lower surface (the surface furthest from UAV 806) of the lower portion parallel with the surface of the landing site, thereby assisting attachment. FIGS. 8A, 8B, and 8C illustrate a rotation about center of mass 812 as lower portion 808 is lowered toward full engagement with the surface of the landing site.

In some embodiments or implementations, the payload attachment system can be operated independently of the UAV 806. The payload attachment system can have independently operated sensors, and a separate control system. The payload attachment system may, for example, be able to automatically (i.e., without operator intervention) position and orient the payload in readiness for attachment at the landing site. The payload attachment system may use, for example, one or more ultrasonic sensors, and/or infra-red or LIDAR (light detection and ranging) sensors, as well as one or more cameras and vision systems.

The degree of autonomy of the payload attachment system may vary from the degree of autonomy of the UAV. Operation of the payload attachment system may be semi-autonomous or fully autonomous. Autonomy may be open-loop or closed-loop. Closed-loop autonomy may depend on status of the payload.

In some embodiments or implementations, operation is open-loop, and proceeds as follows: a) in a location change state, the UAV moves to a first designated position and pauses for first set amount of time, b) in an approach state, the payload attachment system automatically registers the surface and attempts attachment (for example, by rotating a lower portion of the payload attachment system to have a similar orientation), c) in a function state (assuming that the payload attachment system successfully attached the payload to the surface), payload function occurs for a second set amount of time, d) in a detachment-ready state, the payload attachment system reduces a strength of attachment (e.g., lowers pressure in the vacuum cap) for easy detachment, and e) in a detachment state, the UAV moves to a second designated position after a third set amount of time passes.

In some embodiments or implementations, operation of the UAV 806 and the payload is coordinated by a human operator. For example, the operator can determine when the payload's actions are complete and can command the UAV 806 to detach and to complete its mission and/or to move to another location. In some embodiments or implementations, operation of the UAV 806 and the payload is closed-loop. In closed-loop operation, the UAV 806 can detect when the payload's actions at a particular location are complete, and the UAV can complete its mission and/or move to another location. Similarly, in closed-loop operation, the UAV 806 may receive feedback from the payload or the payload attachment system that the payload attachment system is having difficulty attaching to a surface. The UAV 806 may then decide to move to another position to attempt attachment. In some embodiments or implementations, detachment of the payload attachment system can be triggered by the payload. In some embodiments or implementations, positional information from the payload can be used to adjust the UAV 806 position to move closer to the surface if the UAV 806 is unable to register and to attach to the surface, for example.

In some embodiments or implementations, a UAV pilot can move the UAV 806 to a first designated position manually, and then move the UAV to a second designated position manually when the UAV pilot receives feedback via a user interface that the payload is ready to be moved. Operation of the UAV 806 may be semi-autonomous or fully autonomous.

Alternate embodiments of the loaded UAV 800 of FIGS. 8A-8C are contemplated. For example, one or more embodiments described in conjunction with FIGS. 1-7B and 9A-11D may be applicable to the loaded UAV 800 of FIGS. 8A-8C.

### Docking and Undocking

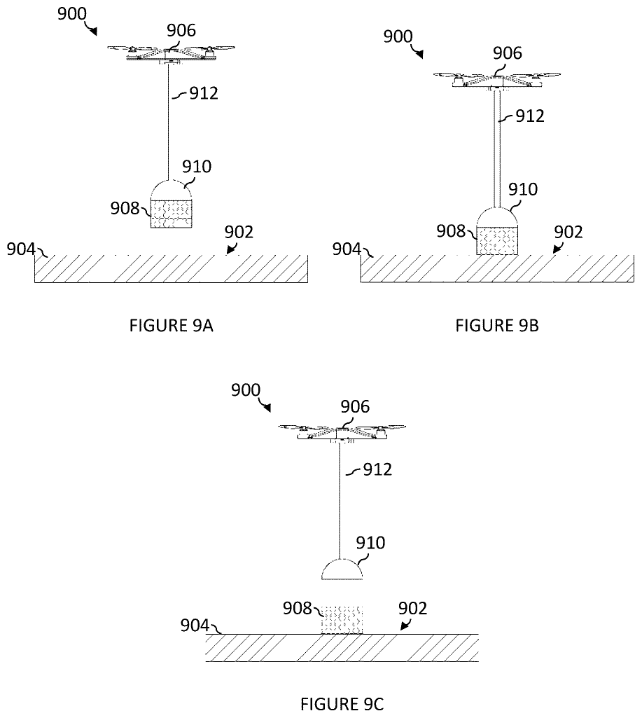

FIGS. 9A, 9B, and 9C are schematic diagrams illustrating an example undocking sequence, in accordance with an embodiment.

In FIG. 9A, a loaded UAV 900 approaches a surface 902 of a landing site 904. Loaded UAV 900 includes a UAV 906, an attachment system 908, a docking system 910, and an umbilical 912. Attachment system 908 may include a payload.

In FIG. 9B, attachment system 908 attaches to surface 902.

In FIG. 9C, docking system 910 decouples from attachment system 908. After decoupling, UAV 906 is able to fly away. At a later time, UAV 906 can return and re-dock with attachment system 908. Attachment system 908 may subsequently detach from surface 902.

In some implementations, docking/undocking includes the use of electromagnets, a quick release, and/or suction.

Alternate embodiments of the loaded UAV 900 of, and the method described in conjunction with, of FIGS. 9A-9C are contemplated. For example, one or more embodiments described in conjunction with FIGS. 1-8C and 10A-11D may be applicable to the loaded UAV 900 of, and the method described in conjunction with, FIGS. 9A-9C.

### Decoupled Operation

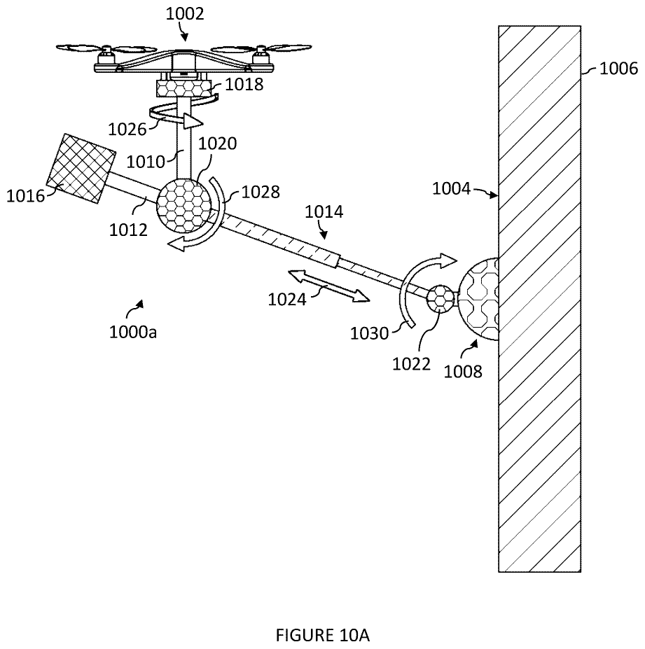

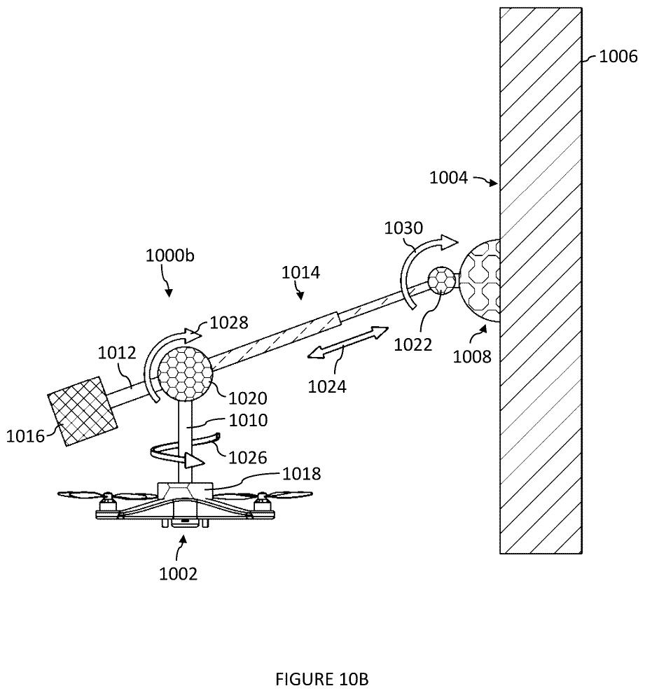

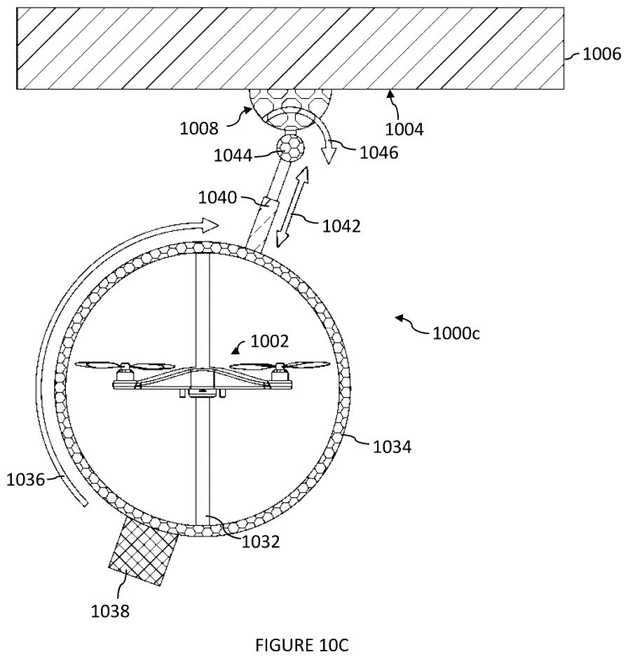

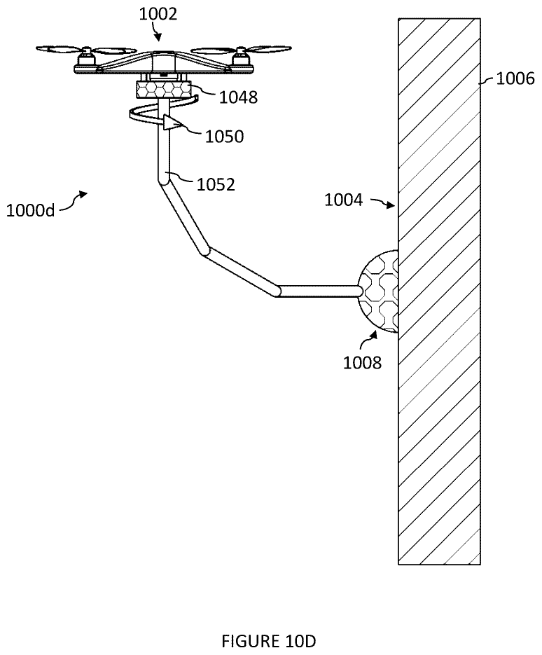

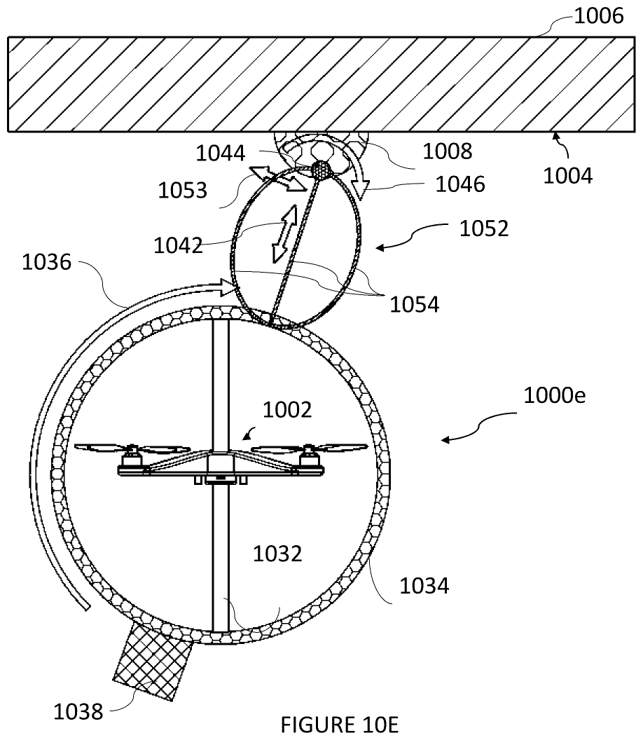

FIGS. 10A, 10B, 10C, 10D and 10E are schematic diagrams illustrating various example implementations of a decoupling system, in accordance with an embodiment.

In some embodiments or implementations, the decoupling system includes an umbilical. The umbilical can include one or more of a rope, chain, hose, spring, flexible, semi-rigid, or rigid member, slide, and/or pivot. A good example of “a semi-rigid member, a semi-rigid arm, and a semi-rigid segment” as used herein is a rod or tube made of a carbon fiber material and whose physical shape changes when external force is exerted on the rod or tube but returns to the original shape (i.e., the physical shape of the rod or tube while no external force is exerted on the rod or tube) when the force disappears.

In some implementations, the decoupling system can be unlocked (to decouple) and locked (to return the system to a coupled state). In some implementations, the decoupling system includes one or more of a motor, solenoid, pneumatic, and/or artificial muscle. As described above with reference to FIGS. 9A, 9B, and 9C, in some embodiments or implementations, the decoupling system can be a release that detaches the payload from the UAV.

In some embodiments or implementations, the decoupling system is mounted on the top or the side or the bottom of the UAV. In some implementations, the decoupling system includes a mounting ring to allow the payload to move around the UAV.

Various example embodiments or implementations are illustrated in FIGS. 10A, 10B, 10C, 10D and 10E, and are described below. In FIGS. 10A, 10B, 10C, 10D and 10E, a UAV 1002 is attached to a surface 1004 of a structure 1006. UAV 1002 includes a lower portion 1008 of a payload attachment system. Lower portion 1008 may include an integrated payload.

FIG. 10A illustrates an example implementation of a decoupling system 1000a, in accordance with an embodiment. Decoupling system 1000a may be part of a payload attachment system (for example, payload attachment system 106 of FIG. 1). Decoupling system 1000a includes rigid members 1010 and 1012, a telescope system 1014, a counterweight 1016, and rotators 1018, 1020, and 1022. In some implementations, one or both of rigid members 1010 and 1012 can be replaced by telescope systems. Telescope system 1014 telescopes in directions indicated by arrows 1024. Decoupling system 1000a allows rotation about rotators 1018, 1020, and 1022 in directions indicated by arrows 1026, 1028, and 1030, respectively (or in opposite directions). A position of counterweight 1016 relative to rotator 1020 may be adjustable, for example by sliding or by telescoping. Decoupling system 1000a is mounted on a bottom surface or other bottom portion of UAV 1002. In some embodiments or implementations, at least one of rotators 1018, 1020, and 1022 includes a motor.

Decoupling system 1000b of FIG. 10B includes the same or similar elements to decoupling system 1000a of FIG. 10A, except that decoupling system 1000b is mounted on a top surface or other top portion of UAV 1002.

FIG. 10C illustrates another example embodiment of a decoupling system 1000c. Decoupling system 1000c includes a strut 1032 running vertically through UAV 1002. Strut 1032 lies along, and is as long as, a diameter of a circular rotator 1034 configured to allow rotation of the rotator 1034 relative to the strut 1032 in a direction indicated by arrow 1036 (or in an opposite direction). The decoupling system 1000c includes a counterweight 1038, and a telescope system 1040 configured to telescope in directions indicated by arrow 1042. The decoupling system 1000c also includes a rotator 1044 configured to allow rotation in a direction indicated by arrow 1046 (or in an opposite direction).

FIG. 10D illustrates yet another example embodiment of a decoupling system 1000d. Decoupling system 1000d includes a rotator 1048 configured to allow rotation in a direction indicated by arrow 1050 (or in an opposite direction). Decoupling system 1000d further includes an articulated arm 1052. Articulated arm 1052 may include rigid or semi-rigid segments, and flexible couplings, joints or hinges, and can orient the arm by use of motors, pneumatic artificial muscles, and/or shape memory materials, for example.

FIG. 10E illustrates yet another example embodiment of a decoupling system 1000e. Decoupling system 1000e includes a strut 1032 running vertically through UAV 1002. Strut 1032 lies along, and is as long as, a diameter of a circular rotator 1034 configured to allow rotation in a direction indicated by arrow 1036 (or in an opposite direction). The decoupling system 1000e includes a counterweight 1038, and an articulating arm 1052 which includes one or more flexible rods 1054, which can be used together to form a semi-rigid segment that allows translational motion in directions indicated by arrows 1042 and 1053. Articulated arm 1052 also may include rigid or semi-rigid segments, and flexible couplings, joints or hinges, and can orient itself by use of motors, pneumatic artificial muscles, and/or shape memory materials, for example.

Alternate embodiments of the decoupling systems 1000a-1000e of FIGS. 10A-10E are contemplated. For example, one or more embodiments described in conjunction with FIGS. 1-9C and 11A-11D may be applicable to the decoupling systems 1000a-1000e of FIGS. 10A-10E.

### Detachment System

In some embodiments or implementations, a UAV system includes a detachment system that allows the UAV to remove a payload from a landing site. It can be advantageous, for example, in some applications, to be able to remove the payload from the landing site without having a significant impulse caused by the payload dropping under gravity. An impulse from the payload dropping could put a strain on the UAV's drive and control system, which could lead to a loss of control of the vehicle.

In some implementations, the detachment system is activated by a mechanical system. In other implementations, the detachment system is activated by an electronic system. The electronic system may include a control system and/or may interface to a payload controller or a UAV controller. Detachment may be activated autonomously or under control of a human pilot, a payload control station (for example, payload control station 120), and/or a UAV control station (for example, UAV control station 118).

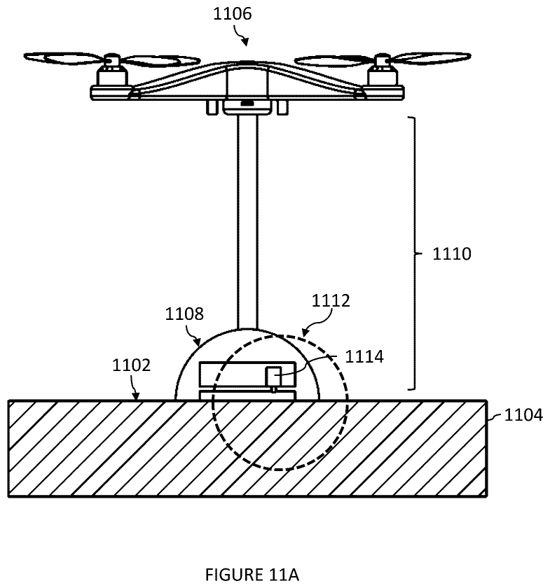

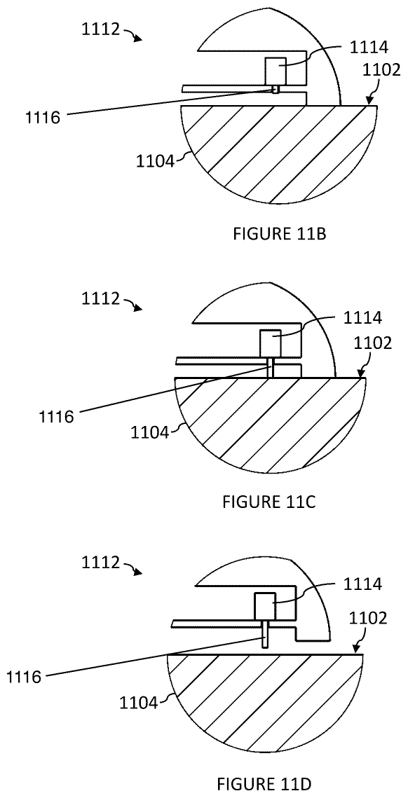

FIG. 11A is a schematic diagram of an example detachment system 1100, in accordance with an embodiment. FIG. 11A shows a surface 1102 on a landing site 1104. Landing site 1104 may be a building or a structure, for example. Surface 1102 may be a horizontal, vertical, or angled surface. UAV 1106 has attached, to surface 1102, a lower portion 1108 of payload attachment system 1110. Lower portion 1108 may include an integrated payload (not shown in FIGS. 11A, 11B, 11C, and 11D). A payload integrated with a lower portion of a payload attachment system is described above with reference to FIGS. 7A and 7B. Lower portion 1108 may be removed from surface 1102 by a detachment assembly 1112 (indicated by dashed lines).

Detachment assembly 1112 includes a solenoid 1114 to push a payload attachment system 1110 and/or lower portion 1108 away from surface 1102 for detachment of lower portion 1108 from the surface.

FIGS. 11B, 11C, and 11D are close-ups of detachment assembly 1112 illustrating a detachment sequence, in accordance with an embodiment.

In FIG. 11B, detachment assembly 1112 is inactive.

In FIG. 11C, the solenoid 1114 extends a pushing member, here a rod, 1116 of detachment assembly 1112 such that the end of the rod contacts, and, therefore, engages, the surface 1102.

And, in FIG. 11D, detachment assembly 1112 has successfully initiated detachment of lower portion 1108 from surface 1102 by the solenoid 1114 extending the rod 1116 a distance sufficient to cause the lower portion 1108 to disengage from the surface 1102. That is, the extending rod 1116 pushes the lower portion 1108 away from the surface 1102.

Alternate embodiments of the detachment system 1100 and detachment assembly 1112 of FIGS. 11A-11D are contemplated. For example, one or more embodiments described in conjunction with FIGS. 1-10E may be applicable to the detachment system 1100 and/or the detachment assembly 1112 of FIGS. 11A-11D.

### Example Embodiments

Example 1 includes a method of operation of a UAV system, the UAV system comprising a UAV, a payload deployment system, and a payload, the payload deployment system comprising a payload attachment system, a payload decoupling system, and a payload detachment system, the method comprising: attaching, by the payload attachment system, the payload at a landing site; decoupling, by the payload decoupling system, the payload from the UAV; and detaching, by the payload detachment system, the payload from the landing site.

Example 2 includes the method of Example 1, the payload attachment system further comprising one or more motors, wherein the attaching, by the payload attachment system, the payload at a landing site includes orienting the payload attachment system relative to the landing site by at least one of the motors.

Example 3 includes the method of any of Examples 1-2, wherein the orienting the payload attachment system relative to the landing site by at least one of the motors includes orienting the payload attachment system by at least one of a yaw motor, a pitch motor, or a roll motor.

Example 4 includes the method of any of Examples 1-3, the payload attachment system further comprising a vacuum system, wherein the attaching, by the payload attachment system, the payload at a landing site includes generating a vacuum by the vacuum system to cause the payload to attach to the landing site.

Example 5 includes the method of any of Examples 1-4, wherein the decoupling, by the payload decoupling system, the payload from the UAV includes decoupling, by the payload decoupling system, the payload from the UAV when the attached payload is at least partially supported at the landing site.

Example 6 includes the method of any of Examples 1-5, further comprising maneuvering the decoupled UAV with a predetermined range of motions.

Example 7 includes the method of any of Examples 1-6, wherein the decoupling, by the payload decoupling system, the payload from the UAV includes decoupling, by the payload decoupling system, the payload from the UAV when the attached payload is fully supported at the landing site.

Example 8 includes the method of any of Examples 1-7, the UAV system further comprising a payload control station, the payload control station comprising a payload controller, the method further comprising actioning, by the payload controller, the payload to perform a task.

Example 9 includes the method of any of Examples 1-8, the payload comprising one or more sensors selected from the group including of an accelerometer, a microphone, a hydrophone, a contact microphone, a laser vibrometer, an ultrasound sensor, an Eddy current sensor, a surface profiler, and an electromagnetic acoustic transducer, wherein the actioning, by the payload controller, the payload to perform a task includes actioning, by the payload controller, the payload to collect data from at least one of the sensors.

Example 10 includes the method of any of Examples 1-9, the payload comprising one or more tools selected from the group including of a paint sprayer, a marker, a drill, an actuated knife, and a laser, wherein the actioning, by the payload controller, the payload to perform a task includes actioning, by the payload controller, the payload to use at least one of the tools.

Example 11 includes the method of any of Examples 1-10, the payload attachment system which comprises a first RF module, the payload control station which comprises a second RF module, the second RF module being communicatively coupled to the first RF module, wherein the actioning, by the payload controller, the payload to perform a task includes transmitting commands, by the second RF module to the first RF module.

Example 12 includes the method of any of Examples 1-11, wherein the payload is mechanically coupled to the UAV via the payload deployment system during a) the attaching, by the payload attachment system, the payload at a landing site, b) the decoupling, by the payload decoupling system, the payload from the UAV, c) the actioning, by the payload controller, the payload to perform a task, and d) the detaching, by the payload detachment system, the payload from the landing site.

Example 13 includes the method of any of Examples 1-12, the detachment system comprising a solenoid, wherein the detaching, by the payload detachment system, the payload from the landing site includes operating the solenoid to push the payload away from the landing site.

Example 14 includes an unmanned aerial vehicle (UAV) system comprising: a UAV; a payload; a payload deployment system comprising: a payload attachment system; a payload decoupling system; and a payload detachment system; and a ground system.

Example 15 includes the system of Example 14, wherein the payload attachment system is configured to attach the payload at a landing site, the payload decoupling system is configured to decouple the payload from the UAV, the decoupled payload being at least partially supported at the landing site, and the decoupled UAV being free to move within a predetermined range of motions, and the payload detachment system is configured to cause the payload to detach from the landing site.

Example 16 includes the system of any of Examples 14-15, wherein the payload attachment system comprises: one or more motors configured to orient the payload attachment system relative to the landing site; one or more sensors; an RF module communicatively coupled to the ground system; and a controller configured to receive data from the sensors and issue commands to the one or more motors, and the RF module.

Example 17 includes the system of any of Examples 14-16, wherein the one or more motors include at least one of a yaw motor, a pitch motor, or a roll motor.

Example 18 includes the system of any of Examples 14-17, wherein the payload attachment system further comprises: a vacuum system, the vacuum system comprising: a vacuum motor; and a vacuum cup pneumatically coupled to the vacuum motor; a pressure sensor configured to determine an air pressure in the vacuum cup; and one or more ultrasonic sensors.

Example 19 includes the system of any of Examples 14-18, wherein the detachment system comprises a vacuum release mechanism configured to adjust an attachment force to allow detachment.

Example 20 includes the system of any of Examples 14-19, wherein the detachment system comprises a solenoid configured to push the payload away from the landing site.

Example 21 includes the system of any of Examples 14-20, wherein the decoupling system comprises an umbilical, the umbilical mechanically coupled at one end to an upper portion of the payload attachment system, the umbilical mechanically coupled at the other end to a lower portion of the payload, and the umbilical configured to allow the UAV to move within a predetermined range of motions when the payload is attached to the landing site.

Example 22 includes the system of any of Examples 14-21, wherein the decoupling system comprises: one or more rigid arms; one or more rotators; a telescope system; and a counterweight.

Example 23 includes the system of any of Examples 14-22, wherein the payload comprises one or more sensors selected from the group including of an accelerometer, a microphone, a hydrophone, a contact microphone, a laser vibrometer, an ultrasound sensor, an Eddy current sensor, a surface profiler, and an electromagnetic acoustic transducer.

Example 24 includes the system of any of Examples 14-23, wherein the payload comprises one or more tools selected from the group including of a paint sprayer, a marker, a drill, an actuated knife, and a laser.

Example 25 includes the system of any of Examples 14-24, wherein the ground system comprises a UAV control station and a payload control station.

Example 26 includes the system of any of Examples 14-25, the payload attachment system which comprises a first RF module, the payload control station which comprises a second RF module, wherein the second RF module is communicatively coupled to the first RF module to transmit commands and to receive data.

Example 27 includes an unmanned aerial vehicle (UAV) system comprising: a UAV; and a payload deployment system comprising: a payload attachment system; a payload decoupling system; and a payload detachment system.

Example 28 includes the system of Example 27, wherein the payload attachment system is configured to attach at least a portion of the payload attachment system at a landing site, the payload decoupling system is configured to decouple at least a portion of the payload attachment system from the UAV, the decoupled at least a portion of the payload attachment system being at least partially supported at the landing site, and the decoupled UAV being free to move within a predetermined range of motions, and the payload detachment system is configured to detach the at least a portion of the payload attachment system from the landing site.

Example 29 includes the system of any of Examples 27-28, wherein the at least a portion of the payload attachment system includes an integrated payload.

Example 30 includes the system of any of Examples 27-29, wherein the payload attachment system is configured to attach a payload at a landing site, the payload decoupling system is configured to decouple the payload from the UAV, the decoupled payload being at least partially supported at the landing site, and the decoupled UAV being free to move within a predetermined range of motions, and the payload detachment system is configured to cause the payload to detach from the landing site.

Example 31 includes a payload deployment system for deploying a payload from a UAV, the payload deployment system comprising at least one of: a payload attachment system; a payload decoupling system; and a payload detachment system.

Example 32 includes a method of operation of a UAV system, the UAV system comprising a UAV and a payload attachment system, the method comprising attaching, by the payload attachment system, a payload at a landing site.

Example 33 includes a method of operating a UAV having a payload deployment system.

Example 34 includes a method of operating a UAV carrying a payload.

Example 35 includes a UAV including a payload deployment system.

Example 36 includes a UAV including a payload.

Example 37 includes a vehicle including a payload.

Example 38 includes a vehicle including a payload deployment system.

Example 39 includes a method of operating a vehicle having a payload deployment system.

Example 40 includes a method of operating a vehicle carrying a payload.

Example 41 includes a UAV.

Example 42 includes a vehicle.

Example 43 includes a method of operating a UAV.

Example 44 includes a method of operating a vehicle.

Example 45 includes a payload.

Example 46 includes a payload deployment system.

Example 47 includes a UAV with an umbilical.

Example 48 includes a vehicle with an umbilical.

Example 49 includes a payload deployment system with an umbilical.

Example 50 includes a payload attachment system.

Example 51 includes a payload decoupling system.

Example 52 includes a payload detachment system.

Example 53 includes an unmanned-aerial-vehicle system comprising: an unmanned aerial vehicle; and a payload deployment system configured for attachment to the unmanned aerial vehicle and comprising: a payload attachment system, a payload decoupling system, and a payload detachment system.

Example 54 includes the system of Example 53 wherein: the payload attachment system is configured to attach a payload at a landing site; the payload decoupling system is configured to decouple the payload from the unmanned aerial vehicle such that the decoupled payload is at least partially supported at the landing site and the decoupled UAV is free to move within a predetermined range of motion; and the payload detachment system is configured to cause the payload to detach from the landing site.

Example 55 includes the system of any of Examples 53-54 wherein the payload attachment system comprises: one or more motors configured to orient the payload attachment system relative to a landing site; one or more sensors; and a controller configured to receive data from the sensors and to issue commands to the one or more motors in response to the data.

Example 56 includes the system of any of Examples 53-55 wherein the one or more motors include at least one of a yaw motor, a pitch motor, and a roll motor.

Example 57 includes the system of any of Examples 53-56 wherein the payload attachment system further comprises: a vacuum cup; a pressure sensor configured to determine a pressure within a space defined by the vacuum cup; a vacuum motor pneumatically coupled to the vacuum cup and configured to pump a fluid from the space in response to a signal from the pressure sensor.

Example 58 includes the system of any of Examples 53-57 wherein the payload detachment system comprises a vacuum release mechanism configured to cause the vacuum motor to reduce the pressure within the space to allow detachment of a payload from the landing site.

Example 59 includes the system of any of Examples 53-58 wherein the payload detachment system comprises a solenoid configured to push a payload away from a landing site.

Example 60 includes the system of any of Examples 53-59 wherein the payload decoupling system includes: an upper portion; a lower portion; and an umbilical coupled between the upper portion and the lower portion and configured to allow the unmanned aerial vehicle to move while a payload is attached to a landing site.

Example 61 includes the system of any of Examples 53-60 wherein the payload decoupling system comprises: one or more arms; and one or more rotators.

Example 62 includes the system of any of Examples 53-61 wherein the payload attachment system comprises an RF transceiver configured to receive a command from a remote source and to transmit data to a remote destination.

Example 63 includes the system of any of Examples 53-62 wherein the payload attachment system includes an integrated payload.

Example 64 includes a method, comprising: positioning a payload at a landing site using an unmanned aerial vehicle; attaching the payload to the landing site; detaching the payload from the landing site; and carrying the payload away from the landing site using the unmanned aerial vehicle.

Example 65 includes the method of Example 64 wherein the attaching includes orienting the payload attachment system relative to the landing site.

Example 66 includes the method of any of Examples 64-65 wherein the orienting includes orienting the yaw, pitch, or roll of the payload attachment system.

Example 67 includes the method of any of Examples 64-66 wherein the attaching includes generating a vacuum between the payload and the landing site.

Example 68 includes the method of any of Examples 64-67 wherein the decoupling includes decoupling the payload from the unmanned aerial vehicle while the attached payload is at least partially supported by the landing site.

Example 69 includes the method of any of Examples 64-68 wherein the payload is mechanically coupled to the unmanned aerial vehicle during the positioning, attaching, detaching, and carrying away.

Example 70 includes the method of any of Examples 64-69 wherein the detaching includes pushing the payload away from the landing site.

Throughout this specification and the appended claims, the term “communicative” as in “communicative coupling” and in variants such as “communicatively coupled,” is generally used to refer to any engineered arrangement for transferring and/or exchanging information. For example, a communicative coupling may be achieved through a variety of different media and/or forms of communicative pathways, including without limitation: electrically conductive pathways (e.g., electrically conductive wires, electrically conductive traces), magnetic pathways (e.g., magnetic media), wireless signal transfer (e.g., radio frequency antennae), and/or optical pathways (e.g., optical fiber). Exemplary communicative couplings include, but are not limited to: electrical couplings, magnetic couplings, radio frequency couplings, and/or optical couplings.

Throughout this specification and the appended claims, infinitive verb forms are often used. Examples include, without limitation: “to encode,” “to provide,” “to store,” and the like. Unless the specific context requires otherwise, such infinitive verb forms are used in an open, inclusive sense, that is as “to, at least, encode,” “to, at least, provide,” “to, at least, store,” and so on.

This specification, including the drawings and the abstract, is not intended to be an exhaustive or limiting description of all implementations and embodiments of the present systems, devices, and methods. A person of skill in the art will appreciate that the various descriptions and drawings provided may be modified without departing from the spirit and scope of the disclosure. In particular, the teachings herein are not intended to be limited by or to the illustrative examples of systems and environments provided.

This specification provides various implementations and embodiments in the form of block diagrams, schematics, flowcharts, and examples. A person skilled in the art will understand that any function and/or operation within such block diagrams, schematics, flowcharts, or examples can be implemented, individually and/or collectively, by a wide range of hardware, software, configuration data, and/or firmware. For example, the various embodiments disclosed herein, in whole or in part, can be equivalently implemented in one or more: application-specific integrated circuit(s) (i.e., ASICs); standard integrated circuit(s); computer program(s) executed by any number of computers (e.g., program(s) running on any number of computer systems); program(s) executed by any number of controllers (e.g., microcontrollers); and/or program(s) executed by any number of processors (e.g., microprocessors, central processing units, graphical processing units), as well as in firmware, and in any combination of the foregoing.

Throughout this specification and the appended claims, a “memory” or “storage medium” is a processor-readable medium that is an electronic, magnetic, optical, electromagnetic, infrared, semiconductor, or other physical device or means that contains or stores processor data, data objects, logic, instructions, and/or programs. When data, data objects, logic, instructions, and/or programs are implemented as software and stored in a memory or storage medium, such can be stored in any suitable processor-readable medium for use by any suitable processor-related instruction execution system, apparatus, or device, such as a computer-based system, processor-containing system, or other system that can fetch the data, data objects, logic, instructions, and/or programs from the memory or storage medium and perform various acts or manipulations (i.e., processing steps) thereon and/or in response thereto. Thus, a “non-transitory processor-readable storage medium” can be any element that stores the data, data objects, logic, instructions, and/or programs for use by or in connection with the instruction execution system, apparatus, and/or device. As specific non-limiting examples, the processor-readable medium can be: a portable computer diskette (magnetic, compact flash card, secure digital, or the like), a random access memory (RAM), a read-only memory (ROM), an erasable (e.g., electrically erasable) programmable read-only memory (EPROM, EEPROM, or Flash memory), a portable compact disc read-only memory (CDROM), digital tape, and/or any other non-transitory medium.

The claims of the disclosure are below. This disclosure is intended to support, enable, and illustrate the claims but is not intended to limit the scope of the claims to any specific implementations or embodiments. In general, the claims should be construed to include all possible implementations and embodiments along with the full scope of equivalents to which such claims are entitled.

1.-74. (canceled)

75. A payload-deployment assembly, comprising:
a payload-attachment subassembly;
a payload-decoupling subassembly; and
a payload-detachment subassembly.

76. The assembly of claim 75 wherein:
the payload-attachment subassembly is configured to attach a payload at a landing site; and
the payload-detachment assembly is configured to cause the payload to detach from the landing site.

77. The assembly of claim 75 wherein the payload-attachment subassembly comprises:
one or more motors configured to orient the payload-attachment subassembly relative to a landing site;
one or more sensors; and
a controller configured to receive data from the one or more sensors and to control the one or more motors in response to the data.

78. The assembly of claim 77 wherein the one or more motors include at least one of a yaw motor, a pitch motor, and/or a roll motor.

79. The assembly of claim 75 wherein the payload-attachment subassembly further comprises:
a vacuum cup;
a sensor configured to determine a pressure within a space defined by the vacuum cup; and
a pump pneumatically coupled to the vacuum cup and configured to remove a fluid from the space in response to a signal from the sensor.

80. The assembly of claim 79 wherein the payload-detachment subassembly comprises a release mechanism configured to reduce a magnitude of the pressure within the space to allow detachment of a payload from a landing site.

81. The assembly of claim 75 wherein the payload-decoupling subassembly comprises:
one or more arms; and
one or more rotators.

82. The assembly of claim 75 wherein the payload-decoupling subassembly comprises:
one or more rigid arms;
one or more rotators;
a telescope system; and
a counterweight.

83. The assembly of claim 75 wherein the payload-attachment subassembly comprises an RF transceiver configured to receive information from a remote source and to transmit information to a remote destination.

84. The assembly of claim 75 wherein the payload-attachment subassembly includes a payload.

85. The assembly of claim 75 wherein the payload-deployment assembly comprises a payload including one or more sensors selected from a group including an accelerometer, a microphone, a hydrophone, a contact microphone, a laser vibrometer, an ultrasound sensor, an Eddy current sensor, a surface profiler, and/or an electromagnetic acoustic transducer.

86. The assembly of claim 75 wherein the payload-deployment subassembly comprises a payload including one or more tools selected from a group including a paint sprayer, a marker, a drill, an actuated knife, and/or a laser.

87. A system comprising:
a payload positioner; and
a payload-deployment assembly configured for attachment to the payload positioner and comprising:
a payload-attachment subassembly,
a payload-decoupling subassembly, and
a payload-detachment subassembly.

88. The system of claim 87 wherein:
the payload-attachment subassembly is configured to attach a payload at a landing site;
the payload-decoupling subassembly is configured to decouple the payload from the payload positioner such that the decoupled payload is at least partially supported at the landing site and the decoupled payload positioner is free to move relative to the payload; and
the payload-detachment subassembly is configured to cause the payload to detach from the landing site.

89. The system of claim 87 wherein the payload-decoupling subassembly includes:
an upper portion;
a lower portion; and
an umbilical coupled between the upper portion and the lower portion and configured to allow the payload positioner to move while a payload is attached to a landing site.

90. The system of claim 87, further comprising:
wherein the payload-attachment subassembly includes a first RF module; and
a payload control station including a second RF module configured to transmit a control signal to, and to receive a data signal from, the first RF module.

91. The system of claim 87 wherein the payload positioner comprises an unmanned aerial vehicle.

92. The system of claim 87, further comprising a ground subsystem configured for controlling the payload-deployment assembly.

93. The system of claim 87, further comprising:
wherein the payload positioner includes an unmanned aerial vehicle;
wherein the payload-deployment assembly includes a payload; and
a ground subsystem including an unmanned-aerial-vehicle control station and a payload control station.

94. A method, comprising:
positioning a payload at a payload-disposition site with a payload positioner;
attaching the payload to the payload-disposition site; and
decoupling the payload from the payload positioner.

95. The method of claim 94 wherein the attaching includes orienting the payload relative to the payload-disposition site.

96. The method of claim 94 wherein the attaching includes generating a vacuum between the payload and the payload-disposition site.

97. The method of claim 94 wherein the decoupling includes decoupling the payload from the payload positioner while the payload is attached to, and is at least partially supported by, the payload-disposition site.

98. The method of claim 94 wherein the payload is mechanically coupled to the payload positioner during the positioning, attaching, and/or decoupling.

99. The method of claim 94, further comprising:
detaching the payload from the payload-disposition site; and
removing payload from the payload-disposition site using the payload positioner.

100. The method of claim 94 wherein the payload positioner comprises an unmanned aerial vehicle.

101. The method of claim 94 wherein the decoupling includes decoupling the payload from the payload positioner while the payload is supported at the payload-disposition site.

102. The method of claim 94, further comprising causing the payload to perform a task while the payload is attached to the payload-disposition site.

103. The method of claim 94, further comprising using a payload controller to cause the payload to perform a task while the payload is attached to the payload-disposition site.
